(19) United States
(12) Patent Application Publication
(10) Pub. No.: US 2020/0042506 A1
(43) Pub. Date: Feb. 6, 2020

(54) METHOD AND COMPONENT FOR CLASSIFYING RESOURCES OF A DATABASE

(71) Applicant: KBLE LTD, Sofia (BG)

(72) Inventor: Ilko GRIGOROV, Sofia (BG)

(21) Appl. No.: 16/601,551

(22) Filed: Oct. 14, 2019

Related U.S. Application Data
(63) Continuation-in-part of application No. 13/874,819, filed on May 1, 2013, now Pat. No. 10,474,714.

(51) Int. Cl. G06F 16/21; G06F 9/451; G06F 3/0484; G06F 3/0481

(52) U.S. Cl. CPC G06F 16/217; G06F 3/0481; G06F 3/0484; G06F 9/451

(57) ABSTRACT

A system for relevant and precise information retrieval includes a processor configured to communicate with a database having a resource set and a user interface component to display a query, a representative set of resources and a representative set of conditions associated with the query. Responsive to user interaction via the user interface component, the system is configured to manage a relevant and precise database by storing, indexing and classifying the resource set based on the one or more user-selected images.

### CROSS-REFERENCE TO RELATED APPLICATIONS

This application is a continuation-in-part application which claims benefit of co-pending U.S. patent application Ser. No. 13/874,819, filed on May 1, 2013, the disclosure of which is herein incorporated by reference in its entireties for all purposes.

### FIELD OF THE INVENTION

The present invention relates to component for classifying resources of a database device, interface and method of forming thereof, and in particular, resources comprising image and/or video data, applicable for text and audio as well, aiming to provide a complete solution to better organize the world information.

### BACKGROUND

Information retrieval systems, or search engines, such as Google Yahoo, BING (Microsoft), Yandex, Facebook, YouTube, Google Photos, Flickr, DuckDuckGo, etc. maintain databases comprising information about web pages and are arranged to provide lists of results, ranked in order of assumed relevance, in response to queries raised by users of the systems. To this end, the systems employ automated software programs to investigate any links they encounter. The contents of each page are then analyzed, indexed accordingly and stored in an index database for retrieval in response to related queries.

In general, the content of the pages is analyzed by extracting words from titles, headings, or special fields such as meta-tags, and classified accordingly. However, for resources comprising image or video based data, information retrieval systems typically rely on context in which the resource is used in order to classify the resource and store it accordingly.

It is appreciated that if images could be labeled according to their content as an alternative or in addition to their context, the retrieval of images by search engines or other such applications could be made much more effective. The problem, however, is how to improve the rate and quality of labeling provided by authors or users.

In order to improve the classification of resources comprising image and/or video data, Google developed Google Image Labeler. Google Image Labeler was a feature of Google Image Search that allows a user to label images to thereby help improve the quality of Google's image search results. By availing of human labeling of images, the images are associated with the meaning or content of the image, as opposed to being indexed solely on the context in which they arose, thereby enabling Google to provide a more accurate and detailed database of resources.

US 2002/0161747 discloses a media content search engine for extracting and associating text content with media content, however, the engine is limited to enabling a user to define whether or not a given piece of content is relevant or not to any given query.

The object of the present invention is to provide an improved method and component for classifying resources of a database.

### SUMMARY

Embodiments of the present disclosure generally relate to component for classifying resources of a database device, interface and method of forming thereof. In one embodiment, an information retrieval system includes a memory including a database, a display including a user interface (UI) component, and a processor. The processor is configured to associate with the UI component to display a query Q, a resource set X, and a set of conditions comprising N conditions C₁-C_{N}. During a user interaction session, the database is configured to categorize resources selected by a user U₁ into subsets of resources Y and store the subsets of resources Y as a collection set of resources S. The database is also configured to operate a plurality of operating modes which are configured to manage the resource set X so as to increase the relevance and precision of the database, and the plurality of operating modes are interchangeably displayed though the UI component. The relevance and precision of the database is based on a group agreement parameter of users viewing resources of the resource set X.

In one embodiment, a method of forming a database for relevant and precise information retrieval includes storing a resource set X in a memory and the resource set X includes a plurality of j resources X₁-Xⱼ. The method proceeds to retrieve from a user interface (UI) component selected resources chosen by a user U₁ from the resource set X and categorize the selected resources into subsets of resources Y_{U1,C1} to Y_{U1,CN} which conform to a set of N conditions C₁-C_{N}. The subsets of resources Y_{U1,C1} to Y_{U1,CN} are stored in the memory as a collection set of resources S_{U1}, where S_{U1}={Y_{U1,C1} to Y_{U1,CN}}, and when there is more than one user, collection sets of resources S_{U1} to S_{UM} for users U₁-U_{M} are stored in the memory. The resource set X is updated by retrieving information from the UI component configured to receive input from the more than one user by operating between interchangeable operating modes. The updating of the resource set X includes verifying descriptions or labels of the resource set X, clarifying the resource set X, resolving ambiguities, and populating a new subset of resources conforming to a given condition.

In one embodiment, a device includes a non-transitory computer readable medium including program instructions executable by a processor. The instructions when executed by the processor, cause the processor to retrieve a resource set X from a database including resources, during a query Q initiated by a user U_{I}. The processor also executes to provide a display via a user interface (UI) component, a representation of the resource set X and a representation of a set of N conditions C₁-C_{N}. The processor further performs the executable instructions by requesting a user U₁ to select the resources from the resource set X which conform to the set of N conditions C₁-C_{N} and assigning a user credibility factor β to the user U_{I} which determines a weighting that is assigned to further selections by the user U_{I}. The UI component is configured to switch between a plurality of operating modes configured to manage the resource set so as to increase the relevance and precision of the database and the database is configured to store, index and classify the resource set based on a group agreement parameter of users viewing the resources in the resource set X.

These and other advantages and features of the embodiments herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

Embodiments of the invention will now be described by way of example with reference to the accompanying drawing, in which:

FIG. 1 illustrates a graphical user interface component provided according to a preferred embodiment of the present invention; and

FIG. 2 illustrates a network comprising a search engine operable to provide the graphical user interface component of FIG. 1.

### DETAILED DESCRIPTION

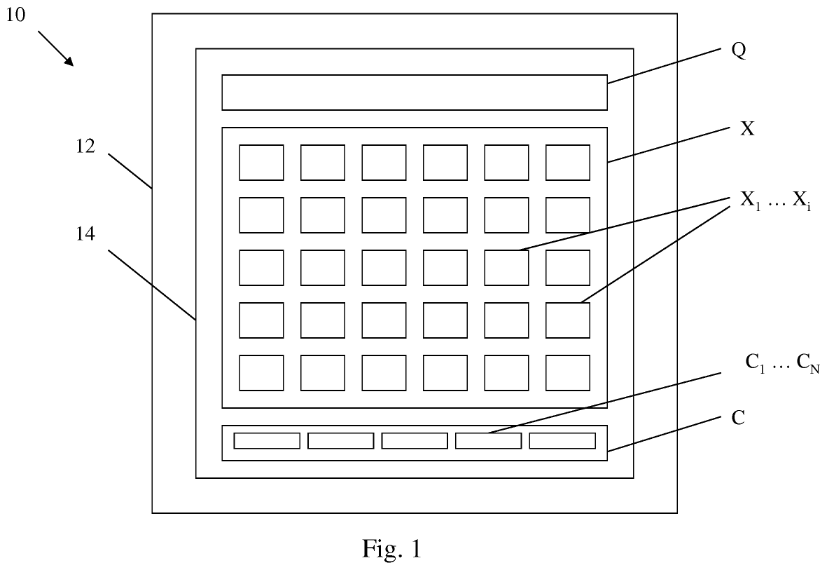

Referring to FIG. 1 of the accompanying drawings, there is illustrated a display 12 provided by an electronic device 10, whereon a user interface component 14 is presented, according to a preferred embodiment of the present invention.

On instigation, as illustrated in FIG. 1, the user interface component 14 displays a resource set X comprising a plurality of resources X₁ to Xᵢ, a query, Q, and a condition set, C, comprising a plurality of conditions C₁ to Cₙ.

In a simple case of the preferred embodiment of the present invention, in response to the query Q, a user is requested to select, from the set of data X, a subset of data Y_{C1}, which conforms to a condition C₁.

For example, the user U may be provided with a query, Q, such as, “Is this a floral image?” or “Floral image”, where the condition, C₁, is “Yes”. Thus, a subset Y_{C1}, of resources selected from the set X, by the user, U, is assumed to comprise floral images.

In one such embodiment, the non-selected resources, of set X are assumed to comprise non-floral images, and are preferably stored as a set Z_{Q}. However, it will be appreciated that the non-selected resources may be nonetheless somewhat related to the condition, for example, the set may comprise an image of a cherry blossom tree, which is not in bloom and as such, the user, U, does not consider the image to satisfy the condition.

By introducing a second condition, C₂, for example, “No”, the user may be requested to select two subsets of resources from the set X, i.e., a first Subset, Y_{C1}, which comprises floral images, and a second Subset, Y_{C2}, which does not comprise floral images, thereby providing the component with a more detailed analysis of the set X.

In such an embodiment, any resources of the set X which were not considered by the user, U, as satisfying either of the conditions C₁ or C₂, and as such, do not belong to Subsets Y_{C1}, or Y_{C2} are preferably retained in a further Subset Z_{Q}, which is considered to comprise resources which relate somewhat to the query, Q, in that they weren't identified as belonging to the Subset Y_{C2}, for example, the non blooming cherry blossom tree.

In an alternative embodiment, the condition C₁ may be ‘relevant’ and the condition C₂ may be ‘irrelevant’. In such an example, the subset Y_{C1}, may comprise floral images, as well as any other images the user deems relevant to the query, such as images of flower shops, florists, or indeed, cherry blossom trees.

Thus, in order to obtain a more refined analysis, in a more comprehensive case, the user is presented with a set of images X, and a set of conditions (C₁, C₂, C₃, . . . C_{N}}, and in response to a query Q, is requested to select subsets of images {Y_{C1}, Y_{C2}, Y_{C3}, . . . Y_{CN}}, from the set X, which conform respectively to the conditions.

For example, consider the case wherein three conditions, C₁, C₂, and C₃ are presented to the user, U, namely, flowers in bloom, flower buds, and wilted flowers. The user U is presented with a set of images, X, and is required to indicate from that set, those that satisfy the first condition, i.e. flowers in bloom, those that satisfy the second condition, i.e., flower buds, and those that satisfy the third condition, i.e. wilted flowers. In this example, the query Q simply asks the user to choose resources from the set X that comply with each condition.

Thus, it will be appreciated that in this case, such a query is somewhat self evident, in particular, due to the conditions presented i.e. C₁, C₂, and C₃ which comprise sufficient information to enable the user to decipher the selections he or she is requested to make. As such, it is appreciated that under certain circumstances, it is not necessary to provide the user with a query, Q.

Retrieval of such information from multiple users with respect to the set of resources X, provides a collection of sets of resources, S={S_{U1}={Y_{U1,C1}, Y_{U1,C2}, Y_{U1,C3}, . . . Y_{UI,CN}}, S_{U2}={Y_{U2,C1}, Y_{U2,C2}, Y_{U2,C3}, . . . Y_{U2,CN}}, . . . , Y., S_{UM}={Y_{UM,C1}, Y_{UM,C2}, Y_{UM,C3}, . . . Y_{UM,CN}}} describing each users selection of resources from the set X, and pertaining to each condition {C₁, C₂, C₃ . . . C_{N}}.

In a preferred embodiment, a group agreement parameter G_{X} is deduced from the sets of resources S for each item presented within the set X={X₁, X₂, X₃ . . . Xᵢ}. In one embodiment, a group agreement parameter G_{XJ} is related to an item Xⱼ associated with a given condition {C₁, C₂, C₃ . . . C_{N}}. The group agreement parameter G_{XJ} is calculated for the item Xⱼ based on the number of users N_{S} who selected the item xⱼ, as being relevant to a given condition {C₁, C₂, C₃ . . . C_{N}} and the number of users N_{U}, who viewed the item Xⱼ. For example, the group agreement parameter G can be determined in a form of a ratio between the N_{S} and the N_{U}. The group agreement parameter G for an item Xⱼ associated with a given condition {C₁, C₂, C₃ . . . C_{N}} can be derived using the following equation:

G=N_{S}/N_{U}. (Equation 1)

where,
N_{S}=number of users who selected the item xⱼ, as being relevant to a given condition {C₁, C₂, C₃ . . . C_{N}}, and
N_{V}=number of users who viewed the item Xⱼ.
The group agreement parameter G, which can be deduced from the sets of resources S for each item, in one embodiment, is a real number between 0 and 1.

In one embodiment, the group agreement parameter G_{X} is used as a weight to be assigned to each item presented within the set X={X₁, X₂, X₃ . . . Xᵢ}. The higher the value of the group agreement parameter G_{X}, for a particular item Xⱼ, the higher is the ranking of the item Xⱼ to the given condition. It should be appreciated that each item presented within the set X can be in the form of any resources such as text, image, video, audio, etc. For example, the group agreement parameter G can be used to determine a weight to be assigned to metadata of an image.

In another embodiment, the group agreement parameter G is utilized for further retrieval and ranking of search results. For example, after calculating the group agreement parameter G for each of the images for a set of images retrieved for a query, the ranking and the order of the images will be re-sorted in accordance with the calculated group agreement parameter G of each image.

A positive group agreement threshold is applied to the group agreement parameter G in a preferred embodiment. The positive group agreement threshold determines whether the items associated with a query are presented before the user when the query is prompted. For example, an item associated with a prompted query and having a group agreement parameter G_{X} which is equal to and/or greater than than the positive group agreement threshold will be presented before the user. An item associated with a prompted query but having a group agreement parameter G_{X} which is lesser than the positive group agreement threshold will not be presented before the user. A higher positive group threshold indicates a higher probability of the relevance of the item associated with the condition. The positive group threshold value depends on the number of users who selected the same item Xⱼ, as being relevant to a given condition. For example, to achieve a high positive group threshold, a greater number of users selecting the same item for a given condition is required.

In the preferred embodiment, each user U={U₁, U₂, U₃ . . . U_{M}} is assigned a user credibility factor, β. The user credibility factor, β, is calculated for each user, based on the discrepancy between selections made by that user, and selections made by the other users, as exemplified by the group agreement parameter G. For example, if an image X, shown to one hundred users is selected by ninety-two of those users as being relevant to a given condition C, and is selected by five of those users as being irrelevant, the user credibility factor, β, associated with those five users having deviated from the norm, is decreased, and the further selections made by those users are considered to carry a lower credibility or weighting.

In another embodiment, the user credibility factor, β, is determined for each user by testing each user with predefined questions having ideal answers. The user credibility factor, β, can be derieved using the following equation:

β=N_{C}/N_{A} (Equation 2)

Where,
N_{C}=number of correct answers for a particular user U
N_{A}=number of questions for a particular user U
The user credibility factor, β, is a real number between 0 and 1.

In one embodiment, the test using predefined questions having ideal answers is conducted in the form of images containing a specific theme or concept. For example, the predefined questions are based on images containing the subject of Golden Retriever dog. The user can be prompted with a predefined question “Is there a Golder Retriever dog on the image?” and the user is required to answer the question by selecting available options provided in the form of different categories such as “Yes”, “No”, “Not sure”, etc. In other cases, the image may be a CAPTCHA image. Other types of images may also be useful.

In one embodiment, users are tested periodically by asking them to classify (or annotate) a set of known resources. For example, users presented with a set of images X, are requested to indicate whether the images display a dog, the first condition being the affirmative, the second condition the negative. The user credibility factor β of those users incorrectly selecting images that do not relate to the query as being affirmative is substantially decreased.

A positive credibility threshold is applied to the user credibility factor, β, in a preferred embodiment. The positive credibility threshold determines whether the selections made by a particular user will be presented when the associated query is prompted. For example, selections by a user having a user credibility factor, β, which is equal to and/or greater than the positive credibility threshold will be presented in accordance to the associated queries. Selections by a user having a user credibility factor, β, lesser than the positive credibility threshold will not be presented. A higher user credibility threshold indicates a higher certainty that the items selected by the particular user will also be selected by other users when viewing the items.

In one embodiment, the user credibility factor is dependent on a user's expertise and knowledge in different fields. One user can have many credibility factors for different domains, queries and conditions. For example, a user who is knowledgeable in one domain like dog breeds can have a high credibility factor above the threshold for the associated domain, but not in another domain such as car models, where the credibility factor of the same user will be low and below the threshold. In such instances, the selections made by the same user in the domain associated with car models will not be considered for in associated queries, conditions or resources.

In another embodiment, the credibility factor of a user is specific and limited to a particular scope in a domain. For example, a user who can recognize 5 specific dog breeds but not others, will have high credibility factors for those 5 dog breeds only. Therefore, when more users use the system (search engine), a better user profiling based on user credibility factor can be determined so that there will be more relevant matching among resources (images, videos, text, etc.), conditions (tags) and users.

In the preferred embodiment, an account comprising a history log is maintained for each user U, from which various statistics, such as the credibility of the user in general, behaviour, accuracy, and attention to detail of the user, may be deduced or derived, allowing user profiling.

In one embodiment of the present invention, it could be used for classification and identification of wrong content, incorrect statements, fake news as well as their authors as users who have wrong understanding on a topic, a single troll and a group of trolls who intentionally publish such content.

In the preferred embodiment of the present invention, the user interface component is arranged to operate in a plurality of modes.

One such mode is ‘Validation Mode’. Information retrieved by the user interface component when operating in ‘Validation Mode’ is designed to verify descriptions of labels of resources. In the preferred embodiment, ‘Validation Mode’ involves the user, U, being presented with two conditions, C₁ and C₂, where C₁ is a condition ‘relevant’ and C₂ is a condition ‘irrelevant’ and requested to select from a set of resources X, two subsets, Y_{C1}, and Y_{C2}.

Another mode is ‘Disambiguation Mode’, which is employed for resolving ambiguities. For example, a user may be provided with a set of images X having associated labels named ‘Mustang’. Accordingly, the user may be requested to create a subset Y_{C1}, comprising images of horses, and a second subset Y_{C2} comprising images of cars.

‘Clarifying Mode’ and ‘Extending Mode’ are modes of user interface component employed for improving sets of resources, which, in the preferred embodiment have been classified or annotated to a certain degree. For example, a user may be presented with a set of images of roses, and requested to create subsets conforming to conditions such as ‘Yellow rose’, ‘Red rose’ and ‘White rose’.

‘New Description’ mode involves providing users with a set of (possibly) random, unlabelled images, X and requesting the user populate a subset Y with images conforming to a given condition, C, for example, images that display a flower.

Creating the different condition or conditions associated with a query can be done in a number of ways.

For example, in new description mode, the terms of the original query can be used to form the condition set C₁, C₂, C₃ . . . C_{N}. Now the user can select a condition from the condition set and then select any displayed images from the resource set which are relevant to that condition; and so on for each condition of the set with which the user wishes to associate one or more images of the resource set.

Alternatively, where a set of images set S1 is displayed in response to a query, a user selects a first image and this becomes a condition C1. The user now selects any further images from the set which are relevant to category C1. Once complete, the user can either select another image from the resource set to start another condition C2, or else any images which have not been selected by the user as relevant to C1 can be labeled as irrelevant to C1—thus the resource set S1 is split to S1-C1-relevant and S1-C1-irrelevant. Optionally, the user can be asked to add a text label to the initial images forming a condition so that these labels might be used for non-image based searching.

In the preferred embodiment, a query Q could be in one language and a condition C in another language.

The information retrieved from the user interface component is subsequently utilized to modify the manner in which descriptions of resources are validated, disambiguated, classified and extended and the manner in which new descriptions are generated for such types of resources. In the preferred embodiment, additional factors, such as the user's account details, such as history log, and credibility rating are further employed in classifying the resources.

Clearly, by availing of direct user feedback in an information retrieval system or search engine the relevance, precision and recall of the classified resources are drastically improved.

In the preferred embodiment, a database is utilized for storage, indexing and classification of the resources.

The database is arranged to store and index resources such as images and video data by means of the context in which the resources arise and where applicable, according to labels describing content of the resources. For example, the database may store a link to a webpage comprising text relating to a florist and an image. Based on the context in which the image was displayed, i.e., a florist's webpage, the image is associated with a florist, and as such, indexed or classified as relating to flowers.

In the case that the image comprises a label or tag, the text of the label may be employed in order to further classify the image. For example, where the label recites bouquet of roses, the image may be classified as being associated with flowers, bouquets and roses.

Furthermore, in accordance with the preferred embodiment of the present invention, the database is arranged to classify the resources stored therein according to information retrieved from the user interface component 14, such as indications to the content of the images, as is described above.

The resources of the database are preferably associated with a set of appropriate conditions C={C₁, C₂, C₃ . . . C_{N}}. For example, where the database comprises an image indexed as a flower, a set of possible conditions associated with the image may include ‘a daisy’, ‘a rose’, ‘a weed’, and ‘other’.

In the preferred embodiment, the resources of the database are associated with at least one query, Q, and a set of query appropriate conditions C_{Q}={C_{Q1}, C_{Q2}, C_{Q3} . . . C_{QN}}. For example, where the database comprises an image indexed as a flower, a possible query associated with the image may be ‘A flower in bloom’, and a set of possible conditions associated with the image may include ‘yes’, ‘no’, and ‘this is not a flower’. However, it will be appreciated that the query may be associated with a generic set of conditions, such as ‘yes’, ‘no’, and ‘don't know ’, or ‘relevant’ and ‘irrelevant’.

It should be appreciated that conditions need not be limited to text and can include images, audio or video, or any combination thereof.

It will be further appreciated that the conditions presented to a user in connection with a specific set of images X, may be determined based on the information currently available in the database. For example, if there is very little information in the database about a particular resource, a generic or unspecific set of conditions may be provided to the user.

In the preferred embodiment, the user interface component 14 operates independently and when invoked, for example, by a user, the user interface component 14, selects a set X of images, corresponding conditions, C={C₁, C₂, C₃ . . . C_{N}}, and possibly a query, Q, for display from the database.

In one embodiment, the details provided to the user are pseudo randomly generated.

However, in the preferred embodiment, the user interface component 12 is arranged to identify the user, and retrieve information previously stored in that user's account, for example, his credibility rating, or information pertaining to any specialist subject the component deems associated with the user based on previous performance. For example, a user who has a history of correctly identifying types of flowers may be presented with a set X that the system has classified as roses, and requested to select a more specific subset comprising English roses.

In the preferred embodiment, information stored in a user's account may be supplemented by the user, to assist the component 14 in providing the user with suitable sets X of images. For example, a user may indicate that he is a botanist. Thus, in the more specialized cases, a botanist would more likely be requested to assist in the identification of images relating to plants, than for example, being requested to assist in the identification of parts of steam engines.

In another embodiment, the user interface component is arranged to operate in conjunction with results provided by an existing search engine, such as Google, Yahoo, and YouTube.

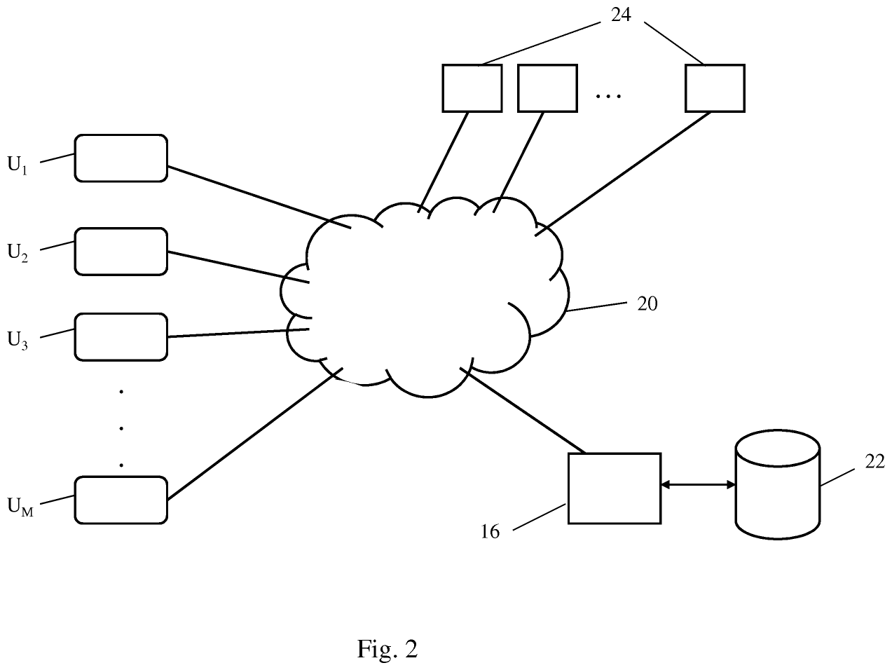

As exemplified in FIG. 2, a plurality of collaborating users, U₁, U₂, U₃ . . . U_{M} are arranged to communicate with a search engine, 16, across a network 20, for example, the Internet. The search engine 16 is in communication with a database 22 comprising resources, such as text, images, video, audio, etc. The resources are retrieved from various sources, such as web pages, 24, by using web crawler applications for example, or from users uploading resources to the search engine, as is the case with applications such as YouTube.

Referring to FIG. 2, on receipt of a search term from a user, U₁, U₂, U₃ . . . U_{M}, the search engine 16 consults the database 22 to retrieve information deemed pertinent to the search term, and displays the information for review by the user in order of relevance. In this case, the list of resources presented to the user by the search engine as search results represent the set of resources X.

According to the preferred embodiment, in the case that the information deemed relevant to the user comprises text, image, audio and/or video data, the user interface component 14 is invoked and at least one condition C, deemed relevant to the search term, is presented to the user.

To this end, search terms are utilized further to consult the database 22 in order to retrieve at least one condition, C, associated with the search term. In one embodiment, the labels indexing images are examined to locate a condition or set of conditions suitable for presentation to the user in connection with the search engine results. In the preferred embodiment, at least the labels indexing images and queries associated therewith are examined to locate a condition or set of conditions suitable for presentation to the user.

For example, a user searching for the term ‘flowers’, is presented with a list of results the search engine deems relevant to the term ‘flowers’. In addition, the term ‘flowers’ is identified as a relatively broad term, and as well as general conditions such as ‘relevant’ and ‘irrelevant’, more specific conditions, such as, ‘wilted’, ‘blooming’, and ‘bouquet’, may be presented to the user to retrieve more in-depth analysis of the images, thereby enabling more accurate indexing of the resources in the database 22.

In the preferred embodiment, specific conditions to be associated with queries are defined at the search engine. So for example, where a common query is identified, say ‘flowers’, it may be considered useful to associate with that query (or broad condition), specific conditions such as ‘wilted’ etc.

Alternatively or in addition, narrow or specific search terms used in combination with a more generic or broader search term, can be stored in the database with the associated broader term and consequently may form the basis for a specific condition for representation with the resource. For example, a user searching for ‘wilted flowers’ may be presented with a number of resources, and conditions associated with those resources and/or search term. In addition, the narrower term Wilted', may be extracted and stored in association with the broader term ‘flowers’ for presentation as a suitable specific condition for a future search for ‘flowers’.

It will be appreciated that although the set of resources is exemplified as images, the set of resources may comprise text, image, audio, video, and/or any combination thereof.

For example, in the case that the set of resources comprises text, a search term ‘Paris’ may prompt the user to be queried ‘Is the following text related to the city of Paris?’, with conditions C₁, and C₂, of ‘Yes’ and ‘No’, respectively, being provided. This information would enable the resources to be more appropriately categorized, by removing text and information related to the celebrity Paris Hilton from a set of resources associated with the city of Paris in France.

Alternatively, or in addition, the query presented to the user may relate to an occurrence of an event in an audio file and/or video file, for example, an event regarding a conversation between a man and a woman. The query presented to the user may be ‘Is the speaker a man’, with the conditions C₁, and C₂, of ‘Yes’ and ‘No’, respectively, being provided. In such an embodiment, account is taken for a time lapse occurring between the instance of the person speaking and the user inputting a response by selecting a condition, to ensure the correct responses of the user are recorded. For example, where a man speaks first, closely followed by a woman speaking, by the time the user has reacted to indicate that a man is speaking, the woman may have begun to speak, a certain amount of time may be accorded to the user to provide the response, to thereby ensure that the correct information is being retrieved from the user and utilized for classification of the resources.

In the preferred embodiment, the search results are grouped together for display in accordance with the information available to the search engine from the database. For example, when a user searches for ‘flowers’, he or she may be presented with multiple images of flowers, which have been grouped together in sub-sets such that all flowers which have been labeled as ‘blooming flowers’, are presented first, followed by a set of flowers which have been labeled as ‘wilted flowers’, followed by a set of flowers which have been labeled as ‘closed’, and so on.

In the preferred embodiment, the graphical user interface presents the conditions as images. For example, the condition ‘wilted’ with respect to images of flowers, is represented as an image of a wilted flower. However, it will be appreciated that the term ‘wilted’ may be used instead of or in combination with the image as a condition. It will be further appreciated that the graphical user interface can be arranged to present the conditions as text, image, audio or video, or any combination thereof.

The present invention may be further implemented as a game, whereby one or more players are provided with sets of resources X, which they are required to classify according to conditions C, provided, in response to queries, Q, posed. The game may involve various degrees of difficulty, including time limits, varying sizes of sets of resources, content and numbers of competitors.

The present invention may also be implemented as a contribution scheme, whereby users are awarded for contributing to the classification of the resources. For example, the reward may be delivered in a point system scale, whereby a user, having exceeded a certain points level, is rewarded by being published as having ‘top score’ in relation to the classification of a specific subject, for example.

The present invention is described in the context of a desktop computer and Web environment, but may either be run as a stand-alone program, or alternatively may be integrated in existing applications, operating systems, or system components to improve their functionality.

From the above description, it should be clear that queries can either be: user defined by inputting a query through the user interface; selected from a predefined by the system; or indeed queries could be machine generated.

Equally, conditions can either be: user defined through interaction with the user interface; selected from a pre-defined list; or machine generated.

Thus while in some cases the condition(s) could be the same as or correspond with the query, in others, the conditions can either be a part of the query, a variation of the query or be derived from the query so allowing for the many use cases of the invention outlined above.

The present disclosure may be embodied in other specific forms without departing from the spirit or essential characteristics thereof. The foregoing embodiments, therefore, are to be considered in all respects illustrative rather than limiting the invention described herein. The scope of the invention is thus indicated by the appended claims, rather than by the foregoing description, and all changes that come within the meaning and range of equivalency of the claims are intended to be embraced therein.

1. An information retrieval system comprising:
a memory, wherein the memory comprises a database;
a display comprising a user interface (UI) component; and
a processor, wherein the processor is configured to
associate with the UI component to display
a query Q,
a resource set X, and
a set of conditions comprising N conditions C₁-C_{N},
wherein during a user interaction session, the database is configured to categorize resources selected by a user U₁ into subsets of resources Y and store the subsets of resources Y as a collection set of resources S, and
operate a plurality of operating modes configured to manage the resource set X so as to increase the relevance and precision of the database, wherein the operating includes switching between the plurality of operating modes which are displayed though the UI component, wherein the relevance and precision of the database is based on a group agreement parameter of users viewing resources of the resource set X.

2. The system of claim 1, wherein the group agreement parameter comprises of a plurality of group agreement parameters, wherein a group agreement parameter G_{Xp,Ct} is determined for each resource Xₚ associated with a certain condition Cₜ in the resource set X, wherein the certain condition Cₜ can be from the N conditions C₁-C_{N}.

3. The system of claim 2, wherein the group agreement parameter G_{Xp,Ct} is equal to N_{S}/N_{U}, wherein
N_{S}=number of users who selected the resource Xₚ associated with the certain condition Cₜ, and
N_{U}=number of users who viewed the resource Xₚ, and
wherein the G_{Xp,Ct} is a real number between 0 to 1, wherein the group agreement parameter G_{Xp,Ct} is assigned as a weight to the each resource Xₚ associated with the certain condition Cₜ in the resource set X.

4. The system of claim 3, wherein the each resource Xₚ in the resource set X is reordered based on the weight assigned.

5. The system of claim 1, wherein the processor is further configured to assign each of one or more users a credibility factor β, wherein the user credibility factor β is based on a discrepancy between selections made by one of the one or more users and selections made by other users, wherein the user credibility factor β determines a weighting which is assigned to further selections by the each of the one or more user.

6. The system of claim 5, wherein the user credibility factor β is equal to N_{C}/N_{A}, wherein
N_{C}=number of correct selections associated with a set of predefined questions,
N_{A}=number of questions in the set of predefined questions,
wherein the correct selections are based on comparing against predefined selections associated with the set of predefined questions, wherein the user credibility factor β is a real number between 0 to 1.

7. The system of claim 6, wherein the set of predefined questions comprises CAPTCHA images.

8. The system of claim 1 wherein:
the display is on an end user device of the user U₁;
the processor is part of a search engine;
wherein the search engine is in communication with the processor;
wherein the end user device communicates with the search engine over a network and collaborates M users U₁-U_{M} to classify the resource set X, wherein the resource set X comprises images, videos, text, audio, or any combination thereof.

9. The system of claim 1, wherein the plurality of operating modes comprises:
a validation mode, wherein the validation mode requests the user to verify descriptions or labels of the resources;
a clarifying mode, wherein the clarifying mode requests the user to improve the resource set to create the subsets of resources;
a disambiguation mode, wherein the disambiguation mode requests the user to create the subsets of resources to resolve ambiguities; and
a new description mode, wherein the new description mode requests the user to populate a subset of resources conforming to a given condition.

10. A method of forming a database for relevant and precise information retrieval comprising:
storing a resource set X in a memory, wherein the resource set X comprises a plurality of j resources X₁-Xⱼ;
retrieving from a user interface (UI) component selected resources chosen by a user U₁ from the resource set X;
categorizing the selected resources into subsets of resources Y_{UI,C1} to Y_{UI,CN} which conform to a set of N conditions C₁C_{N};
storing the subsets of resources Y_{UI,C1} to Y_{UI,CN} in the memory as a collection set of resources S_{UI}, where S_{UI}={Y_{UI,C1} to Y_{UI,CN}}, wherein when there is more than one user, collection sets of resources S_{UI} to S_{UM} for users U₁-U_{M} are stored in the memory; and
updating the resource set X by retrieving information from the UI component configured to receive input from the more than one users by switching between a plurality of operating modes, wherein the updating comprises
verifying descriptions or labels of the resource set X,
clarifying the resource set X,
resolving ambiguities, and
populating a new subset of resources conforming to a given condition.

11. The method of claim 10, further comprising determining a group agreement parameter, G_{Xp,Ct} for each resource Xₚ associated with a certain condition Cₜ in the resource set X, wherein the certain condition Cₜ can be from the N conditions C₁-C_{N}.

12. The method of claim 11, wherein the group agreement parameter G_{Xp,Ct} is equal to N_{S}/ N_{U},
wherein
N_{S}=number of users who selected the resource Xₚ associated with the certain condition Cₜ, and
N_{U}=number of users who viewed the resource Xₚ, and
wherein the G_{Xp,Ct} is a real number between 0 to 1, wherein the group agreement parameter G_{Xp,Ct} is assigned as a weight to the each resource Xₚ associated with the certain condition Cₜ in the resource set X.

13. The method of claim 12, wherein the each resource Xₚ in the resource set X is reordered based on the weight assigned.

14. The method of claim 1, further comprising assigning each of one or more users a credibility factor β, wherein the user credibility factor β is based on a discrepancy between selections made by one of the one or more users and selections made by other users, wherein the user credibility factor β determines a weighting which is assigned to further selections by the each of the one or more users.

15. The method of claim 14, wherein the user credibility factor β is equal to N_{C}/N_{A}, wherein
N_{C}=number of correct selections associated with a set of predefined questions,
N_{A}=number of questions in the set of predefined questions,
wherein the correct selections are based on comparing against predefined selections associated with the set of predefined questions, wherein the user credibility factor is a real number between 0 to 1.

16. The method of claim 15, wherein the set of predefined questions comprises CAPTCHA images.

17. The method of claim 10, wherein the resource set X comprises images, videos, text, audio, or any combination thereof.

18. The method of claim 10, wherein the plurality of operating modes comprises:
a validation mode, wherein the validation mode is configured to perform the verifying of the descriptions or the labels of the resource set X;
a clarifying mode, wherein the clarifying mode is configured to perform the clarifying of the resource set X by requesting the user to improve the resource set X to create the subsets of resources;
a disambiguation mode, wherein the disambiguation mode is configured to perform the resolving of ambiguities by requesting the user to create the subsets of resources; and
a new description mode, wherein the new description mode is configured to perform the populating of a subset of resources conforming to a given condition.

19. A non-transitory computer readable medium including program instructions which, when executed by a processor, cause the processor to perform:
retrieving a resource set X from a database comprising resources during a query Q initiated by a user U_{I};
providing to a display via a user interface (UI) component, a representation of the resource set X and a representation of a set of N conditions C₁-C_{N};
requesting a user U_{I} to select the resources from the resource set X which conform to the set of N conditions C₁-C_{N};
assigning a user credibility factor β to the user U_{I}, wherein the user credibility factor β determines a weighting which is assigned to further selections by the user U_{I},
wherein the UI component is configured to switch between a plurality of operating modes configured to manage the resource set so as to increase the relevance and precision of the database; and
wherein the database is configured to store, index and classify the resource set based on a group agreement parameter of users viewing the resources in the resource set X.

20. The device of claim 19, wherein the user credibility factor β of the user U₁ is related to the number of correct selections associated with a set of predefined questions, wherein the correct selections are based on comparing against predefined selections associated with the set of predefined questions, wherein the set of predefined questions comprises CAPTCHA images.
